(19) United States
(12) Patent Application Publication
(10) Pub. No.: US 2008/0260896 A1
(43) Pub. Date: Oct. 23, 2008

(54) Application of Crude Glycerin for Improved Livestock Production

(76) Inventors: Michael Cecava, Decatur, IN (US); Perry Doane, Decatur, IN (US); David Holzgraefe, Quincy, IL (US); Nathan Pyatt, Decatur, IN (US)

Correspondence Address: ARCHER DANIELS MIDLAND COMPANY, 4666 FARIES PARKWAY, DECATUR, IL, 62526, US

(21) Appl. No.: 12/107,997

(22) Filed: Apr. 23, 2008

Related U.S. Application Data
(60) Provisional application No. 60/913,397, filed on Apr. 23, 2007.

(51) Int. Cl. A23K 1/18; A23K 1/00; A23D 7/005; A23L 1/10; A23L 1/20; A23K 1/12; A23K 1/06

(52) U.S. Cl. 426/2; 426/531; 426/601; 426/622; 426/623; 426/630; 426/636; 426/656; 426/624

(57) ABSTRACT

Methods for using or incorporating glycerin in animal feeds are disclosed. Animal feeds including the glycerin are also disclosed, as well as methods of feeding such animal feeds to animals.

### CROSS-REFERENCE TO RELATED APPLICATIONS

This application claims the benefit of U.S. Provisional Application No. 60/913,397, filed Apr. 23, 2007, the contents of the entirety of which are incorporated by this reference.

### TECHNICAL FIELD

Various non-limiting embodiments of the present disclosure are directed toward a method of improving production in ruminants, monogastrics and other livestock animals.

### BACKGROUND

Approximately ten billion bushels of corn are harvested annually in the United States. Of this quantity, approximately 6.0 billion bushels of corn are utilized as an animal feed, with 1.5 billion bushels of that being utilized as a cattle feed and an additional 0.7 billion bushels being utilized as a feed for dairy cattle, swine, poultry and sheep. Of the remaining quantity, approximately 3.0 billion bushels are processed by wet or dry milling, with over 1.6 billion bushels being processed for ethanol production.

The use of bio-based transportation fuels (i.e., ethanol) in the United States will need to increase from 1.0 percent of U.S. transportation fuel consumption in 2005 to 4 percent of transportation fuel consumption in 2010, to 10 percent in 2020, and to 20 percent in 2030, according to the Roadmap for Biomass Technology in the United States (“Roadmap for Biomass Technologies in the United States.” DOE/Biomass Research and Development Technical Advisory Committee, Biomass Research and Development Initiative-7219. US Department of Energy, Washington, D.C., December 2002). For this to occur, the use of renewable carbohydrates for fuel ethanol must increase dramatically, possibly by the increased use of corn as an ethanol feedstock. If corn presently fed to animals were to be diverted to produce ethanol by dry milling, an additional 5.75 billion gallons of ethanol could be produced. Based on a production of 3.41 billion gallons of ethanol in 2004, this would increase the total ethanol production nearly four-fold without increasing corn acreage planted.

Corn is fed to cattle to provide an inexpensive energy and protein source. The starch in corn is readily fermented in the rumen through the collective action of many genera and species of microbes. The end products of fermentation, microbial biomass, and organic acids (acetate, propionate, butyrate etc.) are utilized by the animal for productive purposes such as meat and milk production. By diverting this corn from cattle feed to ethanol production, two issues will arise. The first issue is the loss of energy from starch for cattle feed, and the second is the additional production of corn dry milling byproducts, which will greatly over-saturate the animal feed market.

Methane is a waste product of rumen fermentation which has been identified as a potential environmental concern and represents a loss of energy and decreased efficiency to animal production. Methane formation is related to the rumen microbial ecology present to ferment available substrates and the hydrogen and electron balance which is sought during fermentation to maximize microbial energetics.

Starch is relatively efficiently fermented in the rumen with moderate losses due to methane. Because fiber is more slowly fermented, contains a more complex sugar profile, and due to the main microbial species involved, the fermentation of fiber results in greater methane production (and energetic loss) relative to starch, with the associated decrease in ruminal propionate and increased acetate to balance the fermentation energetics. Thus, as corn starch is diverted to ethanol production, fiber and protein make up a greater proportion of the feed used for fermentation in ruminant animal nutrition, increasing the potential for methane losses.

As biodiesel production soars, so does crude natural glycerin. For every pound of biodiesel produced, about 0.1 pounds of glycerin is formed. With up to 400 million additional gallons of biodiesel production planned in the United States, the implications of biodiesel production on the nation's glycerin markets are huge. If just 2 percent of the United States' diesel fuel were switched to biodiesel, an additional 325,000 tons of crude glycerin would be produced annually. Glycerin production in the United States has been consistent over the last five years, averaging more than 350,000 tons per year. Reports indicated that the U.S. biodiesel industry is expected to produce an estimated 1.4 billion pounds of glycerin valued at $289 million between 2006 and 2015. Hence a suitable use of the increase in glycerin supply is required (Biodiesel Magazine September 2006).

In the European Union, the turn towards renewable energy sources has increased the production of biodiesel from rapeseed oil (rapeseed oil methyl ester), leaving glycerin as a valuable by-product. Glycerin is a natural, liquid substance of sweet taste which is registered in the European Union as feed additive E 422 (Anonymous, 1995). Lebzien and Aulrich (1993, Schriftenreihe 37, 361-364) have reported a high energy concentration (9.5 MJ of net energy for lactation/kg) and glycerin may therefore have benefits to prevent keto-acidosis in the high yielding dairy cow by increasing the supply of glucose precursors (Sauer et al., 1973, Canadian Journal of Animal Science 53, 265-271).

Because data from the United States suggest that 30 to 50% of all dairy cows are affected by subacute ketoacidosis (Hutjens, 1996, Animal Feed Science and Technology 59, 199-206), means by which energy nutrition of the periparturient cow may be improved are still of special importance. Therefore, glycerin could become attractive for ruminants including, but not limited to, dairy cattle if the amount of the by-product glycerin from biodiesel production exceeds the capacities of the pharmaceutical and chemical industries to process glycerin.

### BRIEF SUMMARY

The various non-limiting embodiments of the present disclosure contemplate glycerin intermixed with animal feed compositions and various methods of increasing animal feed quality, livestock nutrition and value, including, but not limited to, carcass value in beef cattle, swine, poultry and sheep.

In one embodiment, a process for producing an animal feed comprises mixing a source of glycerin having less than 99.0% glycerin and less than 1000 ppm methanol with an animal feed component.

In another embodiment, a method of improving carcass marbling score in an animal, improving carcass ribeye area in an animal, improving body weight gain per unit of feed input in an animal, improving body weight gain per unit of feed input in an animal, improving milk production in an animal, improving carcass gain per unit feed input in an animal, improving energetic efficiency in a growing and/or lactating animal per unit of feed input, and any combinations thereof comprises feeding a source of glycerin having less than 99.0% glycerin and less than 1000 ppm methanol to the animal.

In a further embodiment an animal feed composition comprises a source of glycerin having less than 99.0% glycerin and less than 1000 ppm ethanol and an animal feed component.

### DESCRIPTION OF DRAWINGS

FIG. 1 is a schematic block flow diagram illustrating production of value added products such as glycerin from a plant oil seed.

### DETAILED DESCRIPTION

In each of its various embodiments, the present invention discloses methods for producing animal feed compositions as well as the feed compositions that result from such processes. In various embodiments, these methods and the compositions produced from such methods may be used in improving carcass value, improving milk yield, lowering moisture migration in animal feed pellets, and extending shelf stability of meat products, lowering the freezing point of liquid feed compositions and improving physical handling characteristics of animal feed.

Non-limiting embodiments of the present disclosure are directed toward a composition that improves carcass quality, ribeye area and marbling score in beef stock production. Also disclosed are methods of increasing pellet binding characteristics for animal feeds, producing liquid animal feed compositions that can be utilized at low temperatures and increased propionate yield in ruminal fermentation.

In other embodiments, the methods for producing animal feed pellets and compositions resulting from such methods are used to deliver metabolizable energy to the animals. In certain other embodiments, the teachings of this disclosure may be applied to a plurality of animal feeds including, but not limited to, beef cattle, dairy cattle, sheep, poultry and swine.

In yet other embodiments, the methods may be used to reduce viscosity of liquid feed compositions. A large proportion of animal feed lots are located in the northern, cold climate zones. Consequently, in winter months with the temperature below the freezing point for the bulk of the time, it is important to develop feed formulations that allow easy flowability and delivery of the same to the feed lots. In certain aspects of this embodiment, a solution of crude glycerin may be used to reduce the freezing point of the compositions. Any suitable level of glycerin obtained as a byproduct of biodiesel processing may be used.

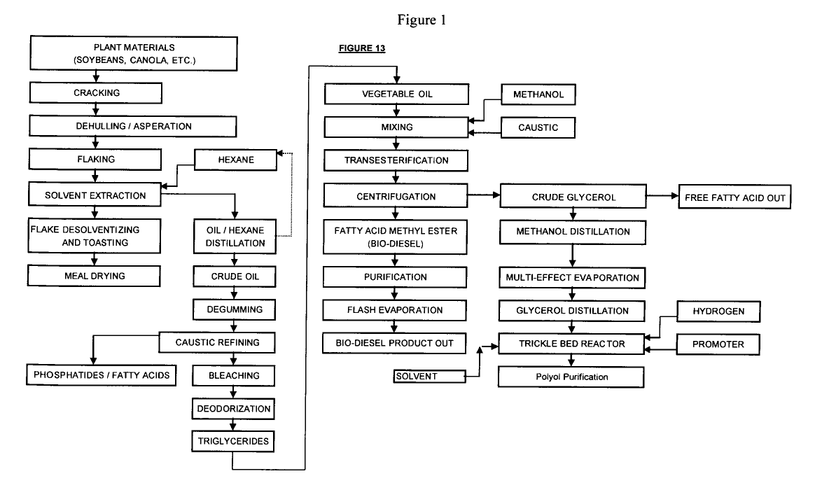

For instance, in one embodiment shown in FIG. 1, the glycerin obtained from transesterification of oils may be used in the production of the animal feed compositions described herein. In certain aspects, the crude glycerin contains between 1 and 20 percent salt by weight. In certain other aspects, the crude glycerin may also contain additional impurities such as fatty acids, organics or methanol. In certain yet other aspects, the glycerin may be treated with an adsorbent to remove some of these impurities. Suitable adsorbents may include, but are not limited to, adsorbent polymeric resins, activated charcoal and the like.

In one embodiment, the glycerin that may used in the present in the present invention is USP (United States Pharmacopeia) grade glycerin having at least 99.5% glycerin. In other embodiments, the glycerin may be a “crude” glycerin having between about 80-99.5% glycerin. In a further embodiment, the glycerin used to produce the animal feed compositions may comprise less than 150 ppm (parts per million) methanol which standard for food grade glycerin in the United States as of the filing date of this application and approved for use in animal feeds in the United States as of the filing date of this application. In another embodiment, the glycerin used to produce the animal feed compositions may comprise less than 1000 ppm methanol.

In certain other embodiments, a method of preparing ready-to-consume animal feed pellets is disclosed. U.S. Pat. No. 5,871,802 (the contents of the entirety of which is incorporated herein by this reference) discloses several of these methods for preparing ready-to-consume animal feed pellets. For instance, in one embodiment, of this invention, feed pellets may be prepared by batching, mixing and pelleting the components of the feed pellets in a commercial mixer. In one embodiment, glycerin may be used as or included in the pellet binder described in U.S. Pat. No. 5,871,802. In another embodiment, feed mash may be fed into the conditioner which discharges the feed into a die/roller assembly where the feed is extruded to form the pellets. In another aspect of this embodiment, a composition containing crude glycerin obtained as a by-product of biodiesel processing may be mixed with the feed mash to improve the properties of the feed pellets.

In other embodiments, a method of improving carcass value is disclosed. In certain aspects of this embodiment, a compostion of animal feed is mixed with crude glycerin. The present invention finds that using crude glycerin in animal feeds results in improved marbling score, greater ribeye area and better carcass values. The present invention also discloses that the use of crude glycerin improves carcass weight and feed productivity. Feed productivity may be defined as weight gained by an animal per unit of feed consumed. For lactating animals, productivity may be defined as the sum of weight gained and milk produced per unit of feed consumed. In certain aspects of this invention, an amount of glycerin in an animal feed may result in higher feed productivities. Similarly, in certain other embodiments in the case of dairy cattle, the present invention enables higher milk productivity and milk output per unit amount of feed when crude glycerin is mixed with the animal feed and fed to the dairy cattle.

In another embodiment, higher poultry weight gain, higher egg output per unit amount of feed is seen when crude glycerin is used as a portion of the animal feed fed to the poultry.

In yet other embodiments, lower drip losses and shelf life is seen in swine meat when the swine is fed a diet containing crude glycerin.

In various embodiments, the animal feed mixture may contain crude glycerin at levels between about 0.5 and about 50 percent of the feed. In another embodiment, the feed may also include one or more components selected from the group consisting of switch grass, corn fiber, corn gluten feed, corn gluten meal, soy protein, soy fiber, soy hulls, cocoa hulls, corn cobs, corn husks, corn stover, wheat straw, wheat chaff, distiller dry grains, distillers dry grains with solubles, barley straw, rice straw, flax hulls, soy meal, corn meal, wheat germ, corn germ, wood chips, sawdust, shrubs, grasses, malt sprouts, whole grains, corn, milo, wheat, barley, protein supplements, minerals, trace minerals, vitamins, canola protein, canola fiber, soapstocks and combinations of any thereof. In certain embodiments, the feed may include liquid animal feeds including, but not limited to, corn steep liquor, condensed distillers' solubles, molasses, corn syrup, animal or vegetable fats, and combinations of any thereof.

In certain other embodiments, the feed may also include a protein source such as, for example, a hydrolyzed vegetable protein or texturized vegetable protein. In certain aspects of this embodiment, roughages and concentrates may also be used.

In another embodiment, a container comprising the animal feed composition of the present invention may be associated with indicia configure to direct a user of the animal feed on how to use the animal feed. For instance, the indicia may direct the user on how much of the animal feed to offer to an animal for obtaining the desired result.

In a further embodiment, the ability of the glycerin containing feed compositions of the present invention to improve carcass marbling score, improve carcass ribeye area, improve carcass weight, improve animal body weight gain per unit of feed input, improve milk production, improve carcass gain in cattle per unit feed input or combinations of any thereof may be enhanced or synergistically combined with other compounds capable of improving carcass marbling score, improving carcass ribeye area, improving carcass weight, improving animal body weight gain per unit of feed input, improving milk production, improving carcass gain in cattle per unit feed input or combinations of any thereof.

For instance, in one embodiment, the glycerin containing feed of the present invention may be combined with a plant botanical or plant extract including, but not limited to, a capsaicin product, cinnamaldehyde, eugenol, or combinations of any thereof. Non-limiting examples of such plant botanicals or extracts are described in US Patent Application Publication 20070209599, published Sep. 13, 2007, the contents of the entirety of which is incorporated by this reference. In this embodiment, the glycerin containing feed of the present invention may also be combined with other sugar alcohols including, but not limited to sorbitol, xylitol, mannitol, or combinations of any thereof. U.S. Pat. No. 7,037,518, the contents of the entirety of which is incorporated herein by this reference, describes compositions including sorbitol that may enhance milk production.

In yet a further embodiment, the glycerin containing feed of the present invention may be combined with a polyol selected from the group consisting of sorbitan, isosorbide, polyglycerin or combinations of any thereof. The ability of sorbitan, isosorbide, polyglycerin or combinations of any thereof to provide dietary energy and/or offset reduced energy balance are described in U.S. patent application Ser. No. 11/956,886, filed Dec. 14, 2007, the contents of the entirety of which is incorporated by this reference.

In another embodiment, the glycerin containing feed of the present invention may be combined with a rumen protected animal feed or prepared in accordance with the teachings of US Patent Application Publication 20060204554, published Sep. 14, 2006, the contents of the entirety of which is incorporated herein by this reference. In one embodiment, the glycerin containing feed of the present invention may be combined with an ingredient selected from the group consisting of an isolated enzyme, an organic acid, a fermentation biomass or combinations of any thereof, as well as a proteinaceous ingredient that has been moist heat treated.

In yet a further embodiment, the glycerin containing feed of the present invention may be combined with a pass-through insect growth regulator. Non-limiting examples of pass-through insect growth regulators include, but are not limited to, granular forms of methoprene present on a solid carrier such as calcite, silica, talc, kaolin, montmorillonite, attapulgite, silica, pumice, kaolin, sepiolite, bentonite, calcite, sand, silica gel, gypsum, charcoal, dry molasses or combinations of any thereof. Examples of shelf-life extending pesticide formulations are disclosed in U.S. Pat. No. 7,163,687, the contents of the entirety of which is incorporated by this reference.

Various embodiments of animal feed compositions according to the present disclosure will be exemplified in the following examples. Those having ordinary skill in the relevant art will appreciate that various changes in the components, compositions, details, materials, and process parameters of the examples that are hereafter described and illustrated in order to explain the nature of the invention may be made by those skilled in the art, and all such modifications will remain within the principle and scope of the invention as expressed herein and in the appended claims. It will also be appreciated by those of ordinary skill in the art that changes could be made to the embodiments described above and below without departing from the broad inventive concept thereof. It is understood therefore, that this invention is not limited to the particular embodiments disclosed, but is intended to cover modifications that are within the principle and scope of the invention, as defined by the claims.

### EXAMPLES

### Example 1

In one embodiment, animal feed pellets were prepared using a 40-hp California pellet mill and conventional steam pelleting processes. Crude glycerin obtained from Archer Daniels Midland Company, Decatur Ill., was used a pellet binder to study its effect on pellet durability index (PDI). In this embodiment, the crude glycerin [FROM SHEET WHEN GET FROM NEIL]

Four treatment groups were formulated to test the response of crude glycerin as a pellet binder. Two corn/soy diets, one with low fat and one with high fat, and two high fiber diets, one with low fat and one with high fat, were formulated to provide the four treatment groups. Within each treatment group, a negative control diet (no binder), positive control diet (0.50% Ameribond 2X, available from Lignotech USA), and two diets containing crude glycerin at 2.5% and 5.0%, respectively, were pelleted. Table 1 references diet formulations tested. The “HFP” referred to in Table 1 refers to a High Fat Product available from Archer Daniels Midland Company, Decatur, Ill. The HFP is a blend of corn and soybean coproducts and typically has a crude protein content of at least 16%, a crude fat content of at least 18%, and a crude fiber content of at least 17%, but no more than 20% crude fiber.

TABLE 1

| | | | High | High | | | High | High |
|---|---|---|---|---|---|---|---|---|
| | Corn/Soy | Corn/Soy | Fiber | Fiber | Corn/Soy | Corn/Soy | Fiber | Fiber |
| | High Fat | Low Fat | High Fat | Low Fat | High Fat | Low Fat | High Fat | Low Fat |
| Ingredient, % | BB 723 | BB 733 | BB 703 | BB 713 | BB 724 | BB 734 | BB 704 | BB 714 |
| HFP | — | — | 25.00 | — | — | — | 25.00 | — |
| Soy Hulls | — | — | 23.89 | 34.37 | — | — | 23.39 | 33.87 |
| Wheat Midds | — | — | 21.56 | 32.32 | — | — | 21.56 | 32.32 |
| Ground Corn | 67.97 | 73.89 | 20.00 | 20.00 | 67.47 | 73.39 | 20.00 | 20.00 |
| 48 Soy | 23.52 | 22.60 | 6.84 | 10.68 | 23.52 | 22.60 | 6.84 | 10.68 |
| Ca Carbonate | 1.96 | 2.00 | 1.92 | 1.84 | 1.96 | 2.00 | 1.92 | 1.84 |
| Dical | 0.76 | 0.72 | — | — | 0.76 | 0.72 | — | — |
| Salt | 0.51 | 0.51 | 0.51 | 0.51 | 0.51 | 0.51 | 0.51 | 0.51 |
| SHP TM PX | 0.20 | 0.20 | 0.20 | 0.20 | 0.20 | 0.20 | 0.20 | 0.20 |
| Sel 0.06% | 0.05 | 0.05 | 0.05 | 0.05 | 0.05 | 0.05 | 0.05 | 0.05 |
| DDP | 0.01 | 0.01 | 0.01 | 0.01 | 0.01 | 0.01 | 0.01 | 0.01 |
| Vit E 50% | 0.01 | 0.01 | 0.01 | 0.01 | 0.01 | 0.01 | 0.01 | 0.01 |
| DAP | 0.01 | 0.01 | 0.01 | 0.01 | 0.01 | 0.01 | 0.01 | 0.01 |
| Ameribond 2X | — | — | — | — | 0.50 | 0.50 | 0.50 | 0.50 |
| Crude Glycerin | — | — | — | — | — | — | — | — |
| Choice White | 5.00 | — | — | — | 5.00 | — | — | — |
| Grease | | | | | | | | |
| Total | 100.00 | 100.00 | 100.00 | 100.00 | 100.00 | 100.00 | 100.00 | 100.00 |
| | 2.5% Crude Glycerin | | | | 5.0% Crude Glycerin | | | |
| | | | High | High | | | High | High |
| | Corn/Soy | Corn/Soy | Fiber | Fiber | Corn/Soy | Corn/Soy | Fiber | Fiber |
| | High Fat | Low Fat | High Fat | Low Fat | High Fat | Low Fat | High Fat | Low Fat |
| Ingredient, % | BB 729 | BB 739 | BB 709 | BB 719 | BB 730 | BB 740 | BB 710 | BB 720 |
| HFP | — | — | 25.00 | — | — | — | 25.00 | — |
| Soy Hulls | — | — | 21.39 | 31.87 | — | — | 18.89 | 29.37 |
| Wheat Midds | — | — | 21.56 | 32.32 | — | — | 21.56 | 32.32 |
| Ground Corn | 65.47 | 71.39 | 20.00 | 20.00 | 62.97 | 68.89 | 20.00 | 20.00 |
| 48 Soy | 23.52 | 22.60 | 6.84 | 10.68 | 23.52 | 22.60 | 6.84 | 10.68 |
| Ca Carbonate | 1.96 | 2.00 | 1.92 | 1.84 | 1.96 | 2.00 | 1.92 | 1.84 |
| Dical | 0.76 | 0.72 | — | — | 0.76 | 0.72 | — | — |
| Salt | 0.51 | 0.51 | 0.51 | 0.51 | 0.51 | 0.51 | 0.51 | 0.51 |
| SHP TM PX | 0.20 | 0.20 | 0.20 | 0.20 | 0.20 | 0.20 | 0.20 | 0.20 |
| Sel 0.06% | 0.05 | 0.05 | 0.05 | 0.05 | 0.05 | 0.05 | 0.05 | 0.05 |
| DDP | 0.01 | 0.01 | 0.01 | 0.01 | 0.01 | 0.01 | 0.01 | 0.01 |
| Vit E 50% | 0.01 | 0.01 | 0.01 | 0.01 | 0.01 | 0.01 | 0.01 | 0.01 |
| DAP | 0.01 | 0.01 | 0.01 | 0.01 | 0.01 | 0.01 | 0.01 | 0.01 |
| Ameribond 2X | — | — | — | — | — | — | — | — |
| Crude Glycerin | 2.50 | 2.50 | 2.50 | 2.50 | 5.00 | 5.00 | 5.00 | 5.00 |
| Choice White | 5.00 | — | — | — | 5.00 | — | — | — |
| Grease | | | | | | | | |
| Total | 100.00 | 100.00 | 100.00 | 100.00 | 100.00 | 100.00 | 100.00 | 100.00 |

Results are presented in Table 2. Meal flow and steam flow were kept constant within the diets in each treatment group. Crude glycerin at 2.5% and 5.0%, respectively, numerically reduced the current usage (amps) on the pellet mill in each treatment group over the negative and positive controls. Crude glycerin at 2.5% and 5.0%, respectively, numerically increased both the PDI without nuts and the PDI with nuts (with the exception of the corn/soy high fat PDI with nuts treatment) in each treatment group over the negative and positive controls. Hence crude glycerin was demonstrated to be a good pellet binder across different types of diets. Similar benefits would apply producing pellets with glycerin using the manufacturing processes described in U.S. Pat. No. 5,871,802, the contents of the entirety of which is incorporated by this reference.

TABLE 2
Crude Glycerin As Pellet Binder

| | | | | | | Initial | Hot | Hot | | |
|---|---|---|---|---|---|---|---|---|---|---|
| Crude | | Sample | | | | Mash | Mash | Pellet | | PDI |
| Glycerin | Type Diet | No. | Steam | Flow | Amps | Temp. F. | Temp. F. | Temp. F. | PDI* | w/nuts** |
| Control | | 733 | 24 | 15 | 15.0 | 69 | 146 | 148 | 77 | 11 |
| Ameribond | Corn/Soy | 734 | 24 | 15 | 14.0 | 68 | 145 | 158 | 86 | 24 |
| 2X 0.50% | | | | | | | | | | |
| Crude | Low Fat | 739 | 24 | 15 | 12.5 | 70 | 147 | 158 | 89 | 33 |
| Glycerin | | | | | | | | | | |
| 2.5% | | | | | | | | | | |
| Crude | | 740 | 24 | 15 | 12.0 | 72 | 153 | 158 | 93 | 46 |
| Glycerin | | | | | | | | | | |
| 5.0% | | | | | | | | | | |
| Control | | 723 | 24 | 20 | 13.5 | 71 | 138 | 138 | 33 | 0 |
| Ameribond | Corn/Soy | 724 | 24 | 20 | 13.5 | 72 | 141 | 148 | 50 | 0 |
| 2X 0.50% | | | | | | | | | | |
| Crude | High Fat | 729 | 24 | 20 | 11.0 | 74 | 142 | 148 | 54 | 0 |
| Glycerin | | | | | | | | | | |
| 2.5% | | | | | | | | | | |
| Crude | | 730 | 24 | 20 | 10.0 | 76 | 142 | 147 | 66 | 0 |
| Glycerin | | | | | | | | | | |
| 5.0% | | | | | | | | | | |
| Control | | 713 | 24 | 20 | 17.5 | 67 | 159 | 168 | 96 | 66 |
| Ameribond | High Fiber | 714 | 24 | 20 | 17.0 | 67 | 161 | 170 | 96 | 71 |
| 2X 0.50% | | | | | | | | | | |
| Crude | Low Fat | 719 | 24 | 20 | 13.5 | 67 | 162 | 172 | 98 | 80 |
| Glycerin | | | | | | | | | | |
| 2.5% | | | | | | | | | | |
| Crude | | 720 | 24 | 20 | 12.0 | 69 | 163 | 170 | 98 | 85 |
| Glycerin | | | | | | | | | | |
| 5.0% | | | | | | | | | | |
| Control | | 703 | 24 | 20 | 13.0 | 65 | 153 | 149 | 74 | 6 |
| Ameribond | High Fiber | 704 | 24 | 20 | 12.5 | 66 | 156 | 158 | 84 | 19 |
| 2X 0.50% | | | | | | | | | | |
| Crude | High Fat | 709 | 24 | 20 | 11.0 | 68 | 157 | 160 | 89 | 26 |
| Glycerin | | | | | | | | | | |
| 2.5% | | | | | | | | | | |
| Crude | | 710 | 24 | 20 | 10.5 | 66 | 156 | 161 | 91 | 37 |
| Glycerin | | | | | | | | | | |
| 5.0% | | | | | | | | | | |

Notes:
Die Size - 3/16″ No Relief
*PDI is determined by tumbling 500 grams of sample in the PDI tumbler for 10 minutes.
**PDI w/nuts is determined by tumbling 500 grams of sample in the PDI tumbler for 10 minutes with 3¾″ nuts and 3½″ nuts.

### Example 2

In another embodiment, the effect of crude glycerin in finishing cattle diets was evaluated. One hundred fifty-eight Angus-cross steers (average initial weight of 387.4 kg) were utilized in a 2×2 factorial to assess the feed value of glycerin and its effects on animal performance and carcass merit. All cattle were adapted on a common 4-step transition prior to initiation of the evaluation. Cattle were blocked by weight (4 blocks) with four pens per treatment (9-10 head/pen). Treatment diets included 0 or 10% crude glycerin to replace cracked corn in a high corn- and co-product-based finishing diet (58 or 51 mega calorie per 100 lbs (Mcal/cwt) net energy for gain (NEg), for high-grain or high co-product diets, respectively). Nutrient analysis of diets is presented in Table 3. Individual weights were collected at 28-day intervals throughout with steers terminated on three harvest dates (days on feed 116 to 153 days) based on weight and condition. Six monthly periods and cumulative (d 1-116 and 1-153) periods were analyzed. Results are presented in Tables 4 and 5.

TABLE 3
Diet Nutrient Analysis

| Treatment | | | |
|---|---|---|---|
| 1 | 2 | 3 | 4 |
| High | High | High | High |
| Grain | Grain + | Co-product | Co-product + |
| Finisher | Glycerin | Finisher | Glycerin |

Nutrient Analysis

| | | | | |
|---|---|---|---|---|
| Dry Matter (DM), % | 71.25 | 71.43 | 71.77 | 71.97 |
| Protein, % | 12.61 | 12.57 | 15.01 | 15.02 |
| Fat; Crude, % | 4.62 | 4.25 | 5.92 | 5.55 |
| Crude Fiber, % | 6.23 | 6.00 | 13.15 | 12.79 |
| Rumen undegraded protein (RUP), % Protein | 41.50 | 37.69 | 43.42 | 41.08 |
| Rumen degraded protein (RDP), % Protein | 58.50 | 62.31 | 56.58 | 58.92 |
| Non-protein nitrogen (NPN), % | 2.30 | 3.15 | | |
| Total Digestible Nutrients (TDN), % | 81.91 | 82.15 | 81.20 | 81.60 |
| Net energy for gain (NEg), mcal/cwt | 62.73 | 62.97 | 61.59 | 62.25 |
| Net energy for maintenance (NEm), mcal/cwt | 92.87 | 93.00 | 87.79 | 88.34 |
| Acid detergent fiber (ADF), % | 7.33 | 7.04 | 17.15 | 16.67 |
| Neutral detergent fiber (NDF), % | 16.45 | 15.47 | 30.33 | 28.49 |
| Calcium, % | 0.60 | 0.78 | 0.64 | 0.94 |
| Phosphorus, % | 0.40 | 0.52 | 0.43 | 0.63 |
| Salt, % | 0.50 | 1.23 | 0.50 | 1.13 |
| Potassium, % | 0.75 | 0.78 | 1.05 | 1.11 |
| Sulfur, % | 0.20 | 0.20 | 0.20 | 0.20 |
| Magnesium, % | 0.25 | 0.25 | 0.25 | 0.22 |
| Zinc, ppm | 69.86 | 69.91 | 75.21 | 71.03 |
| Iron, ppm | 90.76 | 51.95 | 137.76 | 135.60 |
| Copper, ppm | 14.93 | 14.95 | 15.05 | 15.06 |
| Manganese, ppm | 49.82 | 49.84 | 51.43 | 52.26 |
| Cobalt, ppm | 0.41 | 0.38 | 0.25 | 0.25 |
| Iodine, ppm | 0.50 | 0.50 | 0.54 | 0.61 |
| Selenium, ppm | 0.20 | 0.21 | 0.19 | 0.20 |
| Sodium, % | 0.20 | 0.20 | 0.24 | 0.20 |
| Vitamin A, iu/lb | 1738.22 | 1593.96 | 1695.70 | 1676.82 |
| Vitamin D, iu/lb | 152.21 | 165.28 | 174.09 | 172.15 |
| Vitamin E, iu/lb | 10.00 | 10.00 | 10.05 | 10.03 |
| Ash, % | 2.25 | 2.78 | 3.70 | 4.23 |

¹Analyzed values in parentheses.

TABLE 4

| Treatment # | 1 | 2 | 3 | 4 | | | | | | | P Values | | | |
|---|---|---|---|---|---|---|---|---|---|---|---|---|---|---|
| DDGS:Soy | | | | | | | | | | | | | | |
| Hulls, % DM | 10:0 | 10:0 | 30:15 | 30:15 | DDGS:SH, % DM | | | | Glycerin, % DM | | | DDGS: | Glycerin | DDGS:SH |
| Glycerin, | | | | | | | | | | | | | | |
| % DM | 0 | 10 | 0 | 10 | SE | 10:0 | 30:15 | SE | 0 | 10 | | Soy Hulls | | x Glycerin |
| # of Pens | 4 | 4 | 4 | 4 | | 8 | 8 | | 8 | 8 | | | | |
| # of Cattle | 40 | 39 | 39 | 40 | | 79 | 79 | | 79 | 79 | | | | |

Weight, kg

| | | | | | | | | | | | | | | |
|---|---|---|---|---|---|---|---|---|---|---|---|---|---|---|
| Day 0 | 386.8 | 388.3 | 385.6 | 388.9 | | | | | | | | | | |
| Day 28 | 425.9^{ab} | 428.2^{a} | 423.1^{b} | 423.9^{ab} | 1.56 | 427.1 | 423.5 | 1.09 | 424.5 | 426.1 | 1.10 | 0.05 | 0.35 | 0.64 |
| Day 56 | 465.5 | 471.2 | 464.5 | 470.5 | 2.43 | 468.4 | 467.5 | 1.70 | 465.0 | 470.9 | 1.72 | 0.73 | 0.04 | 0.94 |
| Day 84 | 504.2 | 507.3 | 504.1 | 505.4 | 2.79 | 505.8 | 504.8 | 1.95 | 504.2 | 506.4 | 1.97 | 0.72 | 0.46 | 0.75 |
| Day 116 | 531.2 | 538.3 | 537.4 | 535.1 | 3.73 | 534.8 | 536.2 | 2.61 | 534.3 | 536.7 | 2.64 | 0.70 | 0.54 | 0.24 |
| Day 132 | 539.6 | 552.8 | 552.4 | 548.8 | 7.04 | 546.2 | 550.6 | 4.54 | 546.0 | 550.8 | 4.63 | 0.52 | 0.50 | 0.23 |
| Day 153 | 552.6 | 570.5 | 557.5 | 548.0 | 8.51 | 561.5 | 552.8 | 4.62 | 555.0 | 559.3 | 5.21 | 0.27 | 0.58 | 0.11 |

Average Daily Gain, kg/hd/d

| | | | | | | | | | | | | | | |
|---|---|---|---|---|---|---|---|---|---|---|---|---|---|---|
| Day 1-28 | 1.38^{ab} | 1.46^{a} | 1.28^{b} | 1.31^{ab} | 0.06 | 1.42 | 1.29 | 0.04 | 1.33 | 1.38 | 0.04 | 0.05 | 0.35 | 0.64 |
| Day 29-56 | 1.41 | 1.53 | 1.48 | 1.66 | 0.10 | 1.47 | 1.57 | 0.07 | 1.44 | 1.60 | 0.07 | 0.35 | 0.16 | 0.74 |
| Day 57-84 | 1.38 | 1.29 | 1.42 | 1.25 | 0.07 | 1.34 | 1.33 | 0.05 | 1.40 | 1.27 | 0.05 | 0.94 | 0.11 | 0.59 |
| Day 85-116 | 0.84 | 0.97 | 1.04 | 0.93 | 0.10 | 0.91 | 0.98 | 0.07 | 0.94 | 0.95 | 0.07 | 0.43 | 0.95 | 0.25 |
| Day 117-132 | 1.21 | 1.46 | 1.12 | 1.26 | 0.27 | 1.33 | 1.19 | 0.18 | 1.16 | 1.36 | 0.18 | 0.59 | 0.48 | 0.82 |
| Day 133-153 | 0.94^{b} | 1.39^{a} | 0.77^{b} | 0.90^{b} | 0.16 | 1.16 | 0.84 | 0.10 | 0.85 | 1.15 | 0.10 | 0.04 | 0.06 | 0.29 |
| Day 1-116 | 1.24 | 1.30 | 1.29 | 1.27 | 0.03 | 1.27 | 1.28 | 0.02 | 1.27 | 1.29 | 0.02 | 0.70 | 0.54 | 0.24 |
| Day 1-153 | 1.14^{b} | 1.27^{a} | 1.18^{ab} | 1.21^{ab} | 0.03 | 1.20 | 1.19 | 0.02 | 1.16 | 1.24 | 0.02 | 0.71 | 0.04 | 0.14 |

Dry Matter Intake, kg/hd/d

| | | | | | | | | | | | | | | |
|---|---|---|---|---|---|---|---|---|---|---|---|---|---|---|
| Day 1-28 | 8.72^{b} | 7.97^{c} | 9.77^{a} | 8.34^{bc} | 0.20 | 8.34 | 9.06 | 0.14 | 9.24 | 8.16 | 0.14 | 0.01 | 0.001 | 0.12 |
| Day 29-56 | 9.99^{b} | 8.78^{c} | 11.10^{a} | 9.95^{b} | 0.26 | 9.39 | 10.53 | 0.18 | 10.55 | 9.36 | 0.18 | 0.002 | 0.002 | 0.92 |
| Day 57-84 | 9.81^{b} | 8.84^{b} | 10.72^{a} | 9.37^{b} | 0.17 | 9.32 | 10.04 | 0.12 | 10.26 | 9.11 | 0.12 | 0.003 | 0.0001 | 0.30 |
| Day 85-116 | 8.60^{b} | 7.74^{c} | 9.73^{a} | 8.25^{bc} | 0.22 | 8.17 | 8.99 | 0.16 | 9.17 | 8.00 | 0.16 | 0.01 | 0.001 | 0.19 |
| Day 117-132 | 8.49^{b} | 8.67^{ab} | 9.72^{a} | 9.54^{ab} | 0.38 | 8.58 | 9.63 | 0.24 | 9.10 | 9.11 | 0.25 | 0.02 | 0.99 | 0.61 |
| Day 133-153 | 8.04 | 8.48 | 9.20 | 9.42 | 0.89 | 8.26 | 9.31 | 0.57 | 8.62 | 8.95 | 0.55 | 0.21 | 0.67 | 0.89 |
| Day 1-116 | 9.26^{b} | 8.31^{c} | 10.31^{a} | 8.95^{b} | 0.16 | 8.78 | 9.63 | 0.11 | 9.78 | 8.63 | 0.11 | 0.001 | 0.0001 | 0.23 |
| Day 1-153 | 9.11^{b} | 8.37^{c} | 10.19^{a} | 8.99^{b} | 0.16 | 8.74 | 9.59 | 0.11 | 9.65 | 8.68 | 0.11 | 0.001 | 0.0003 | 0.18 |

Gain/Feed, ×100

| | | | | | | | | | | | | | | |
|---|---|---|---|---|---|---|---|---|---|---|---|---|---|---|
| Day 1-28 | 15.80^{b} | 18.27^{a} | 13.05^{c} | 15.64^{b} | 0.52 | 17.04 | 14.35 | 0.36 | 14.42 | 16.96 | 0.37 | 0.001 | 0.001 | 0.91 |
| Day 29-56 | 14.19^{b} | 17.43^{a} | 13.23^{b} | 16.78^{a} | 0.76 | 15.81 | 15.00 | 0.53 | 13.71 | 17.10 | 0.54 | 0.32 | 0.002 | 0.84 |
| Day 57-84 | 14.10 | 14.64 | 13.23 | 13.36 | 0.75 | 14.37 | 13.29 | 0.52 | 13.66 | 14.00 | 0.53 | 0.19 | 0.67 | 0.79 |
| Day 85-116 | 9.76 | 12.47 | 10.63 | 11.22 | 0.98 | 11.11 | 10.93 | 0.68 | 10.20 | 11.84 | 0.69 | 0.85 | 0.13 | 0.30 |
| Day 117-132 | 14.95 | 17.25 | 11.69 | 12.86 | 2.96 | 16.10 | 12.28 | 1.91 | 13.32 | 15.06 | 1.95 | 0.20 | 0.56 | 0.84 |
| Day 133-153 | 11.72^{b} | 16.48^{a} | 8.43^{b} | 9.35^{b} | 1.66 | 14.10 | 8.89 | 1.07 | 10.07 | 12.92 | 1.02 | 0.01 | 0.08 | 0.23 |
| Day 1-116 | 13.41^{bc} | 15.66^{a} | 12.52^{c} | 14.28^{b} | 0.30 | 14.54 | 13.40 | 0.21 | 12.97 | 14.97 | 0.21 | 0.004 | 0.0002 | 0.43 |
| Day 1-153 | 12.48^{c} | 15.21^{a} | 11.54^{d} | 13.43^{b} | 0.28 | 13.85 | 12.48 | 0.20 | 12.01 | 14.32 | 0.20 | 0.001 | <0.0001 | 0.18 |

^{d}Means within the same row with different superscripts differ P < 0.05.

TABLE 5

| Treatment # | 1 | 2 | 3 | 4 | | | | | | | | P Values | | |
|---|---|---|---|---|---|---|---|---|---|---|---|---|---|---|
| DDGS:Soy | | | | | | | | | Glycerin, | | | | | |
| Hulls, % DM | 10:0 | 10:0 | 30:15 | 30:15 | DDGS:SH, % DM | | | | % DM | | | DDGS: | Glycerin | DDGS:SH |
| Glycerin, | | | | | | | | | | | | | | |
| % DM | 0 | 10 | 0 | 10 | SE | 10:0 | 30:15 | SE | 0 | 10 | SE | Soy Hulls | | x Glycerin |
| # of Cattle | 40 | 18 | 37 | 22 | | 58 | 59 | | 77 | 40 | | | | |
| Live Weight, kg | 557.7^{ab} | 581.0^{a} | 555.0^{b} | 563.3^{ab} | 9.07 | 569.3 | 559.2 | 6.26 | 556.3 | 572.2 | 6.45 | 0.25 | 0.08 | 0.39 |
| Adjusted Carcass | 544.5^{b} | 567.9^{a} | 543.8^{b} | 551.4^{ab} | 8.20 | 556.2 | 547.6 | 5.66 | 544.1 | 559.6 | 5.84 | 0.28 | 0.06 | 0.32 |
| Live Wt, kg | | | | | | | | | | | | | | |
| Hot Carcass | 343.0^{b} | 357.7^{a} | 342.6^{b} | 347.4^{ab} | 5.17 | 350.4 | 345.0 | 3.57 | 342.8 | 352.6 | 3.68 | 0.28 | 0.06 | 0.32 |
| Weight, kg | | | | | | | | | | | | | | |
| Dress, % | 61.55 | 61.59 | 61.85 | 61.65 | 0.44 | 61.57 | 61.75 | 0.31 | 61.70 | 61.62 | 0.32 | 0.67 | 0.86 | 0.79 |
| Ribeye Area, | 82.24 | 85.49 | 81.49 | 84.86 | 1.69 | 83.87 | 83.18 | 1.16 | 81.87 | 85.18 | 1.20 | 0.67 | 0.05 | 0.97 |
| sq cm | | | | | | | | | | | | | | |
| Backfat Depth, | 1.46 | 1.40 | 1.40 | 1.48 | 0.09 | 1.43 | 1.44 | 0.06 | 1.43 | 1.44 | 0.06 | 0.86 | 0.93 | 0.45 |
| cm | | | | | | | | | | | | | | |
| KPH Fat, % | 1.89 | 1.90 | 1.97 | 1.87 | 0.10 | 1.90 | 1.92 | 0.07 | 1.93 | 1.88 | 0.07 | 0.84 | 0.67 | 0.56 |
| Yield Grade | 3.14 | 3.01 | 3.14 | 3.07 | 0.13 | 3.08 | 3.11 | 0.09 | 3.14 | 3.04 | 0.09 | 0.83 | 0.45 | 0.77 |
| YG 2, % | 35.0 | 44.4 | 40.9 | 45.0 | | 39.5 | 42.9 | | 38.1 | 44.7 | | 0.76 | 0.55 | 0.80 |
| YG 3, % | 60.0 | 55.6 | 54.6 | 55.0 | | 57.9 | 54.8 | | 57.1 | 55.3 | | 0.97 | 0.87 | 0.82 |
| YG 4, % | 5.0 | 0.0 | 4.6 | 0.0 | | 2.6 | 2.4 | | 4.8 | 0.0 | | 0.95 | 0.18 | NS |
| Marbling Score | 616.4 | 623.1 | 600.4 | 630.1 | 21.86 | 619.7 | 615.3 | 15.08 | 608.4 | 626.6 | 15.55 | 0.83 | 0.40 | 0.58 |
| ³Choice -, % | 95.0 | 94.4 | 95.5 | 95.0 | | 94.7 | 95.2 | | 95.2 | 94.7 | | 0.92 | 0.92 | 1.00 |
| ³Choice 0, % | 60.0 | 66.7 | 50.0 | 65.0 | | 63.2 | 57.1 | | 54.8 | 65.8 | | 0.58 | 0.32 | 0.72 |
| Carcass Value | 989.2^{b} | 1038.6^{a} | 986.8^{b} | 1008.5^{ab} | 17.33 | 1013.9 | 997.6 | 11.96 | 988.0 | 1023.5 | 12.33 | 0.33 | 0.04 | 0.40 |

^{a,b,c,d}Means within the same row with different superscripts differ P < 0.05.
DDGS—Distillers Dry Grains with Solubles,
SH—Soy Hulls,
SE—Standard Error,
YG—Yield grade,
KPH—Kidney, heart, and pelvic fat

No significant (P>0.10) diet type by glycerin interactions were observed; therefore, only main effects will be discussed. On day 28, weight and average daily gain (ADG) response were greater (P=0.05) for steers fed a high-grain diet; however, cumulative ADG was not different among diet types the remainder of the experiment (1.20 vs. 1.19 kg/d, respectively). On day 56, weight and ADG response were greater (P<0.05) for steers fed diets containing 10% crude glycerin; cumulative ADG was 6.9% greater relative to control cattle (1.16 vs. 1.24 kg/d, respectively). Cumulative ADG was 11.4% greater in cattle fed high-grain diets with glycerin and 2.5% better for steers fed high co-product diets with glycerin. Cattle fed high co-product diets maintained 9.7% greater (P<0.05) dry matter intake (DMI) relative to high-grain controls (8.74 vs. 9.59 kg/d, respectively). Similarly, steers fed diets with added glycerin maintained 10.1% lesser (P<0.05) DMI relative to controls (9.65 vs. 8.68 kg/d, respectively).

Of particular interest, cumulative DMI was 8.1% lesser in cattle fed high-grain diets with glycerin and 11.8% lower for steers fed high co-product diets with glycerin. Glycerin negated the increase in DMI traditionally associated with high co-product feeding. Feed efficiency was 11.0% greater (P<0.05) for cattle fed high-grain diets relative to co-product-based rations (0.1385 vs. 0.1248, respectively). Similarly, steers fed diets with added glycerin were 19.2% more (P<0.05) efficient relative to controls (0.1201 vs. 0.1432, respectively). Similar to DMI, cumulative gain: feed was 21.9% greater in cattle fed high-grain diets with glycerin and 16.4% better for steers fed high co-product diets with glycerin. Cattle fed co-product diets with 10% glycerin had feed efficiency intermediate to high-grain diets with and without crude glycerin. For carcass characteristics, no significant (P>0.25) differences were observed for diet type. Steers fed 10% crude glycerin tended (P<0.10) to have greater final and hot carcass weight, ribeye area, and resulting carcass value. Carcass value was calculated using actual carcass weight and associated premiums and discounts for quality and yield grades. The results indicate that growing and finishing ruminants fed (10%) crude glycerin as an energy ingredient had superior growth, efficiency, and carcass merit relative to those fed cracked corn, suggesting greater energy values.

### Example 3

In another embodiment, effects of residual methanol in crude glycerin in ruminant diets was studied. The US Food and Drug Administration has regulated levels of methanol in glycerine to below 150 ppm due to concerns over methanol accumulation in rumen fluid and blood plasma. 40 crossbred steers (average weight 561 kg) were fed high-grain or high co-product finishing rations with a 10% (DM basis) inclusion of crude glycerin (certified kosher; available from Johann Haltermann, Ltd., Houston, Tex.).

Certificate of analysis for methanol concentration for the crude glycerin source was 0.08% (wt.) or 800 ppm. A subset of ten cattle (5 from each treatment) were used for baseline and withdrawal sampling of rumen fluid and blood plasma for residual methanol quantification. Baseline measurements were made while cattle were consuming diets with crude glycerin. After collection of baseline samples, crude glycerin was replaced by cane molasses and all cattle were fed a common high co-product diet for a 16-day withdrawal period. Withdrawal samples were collected from the same subset of animals. Feed (crude glycerin only) and biological samples were analyzed for methanol concentration with a minimum detection limit of 1 ppm. Ingredient samples were stored in sealed totes for approximately 5 months (May to October) prior to submission. Crude glycerin samples analyzed in duplicate averaged similar to the manufacturers certificate of analysis (0.08% or 756 ppm methanol).

Results presented in Table 6 suggest little volalization occurs over time. Analysis of baseline rumen fluid detected 50% of the animals had measurable methanol (≦4.26 ppm). Analysis of rumen fluid after a 16-day withdrawal period detected 100% of the animals had measurable methanol (≦23.77 ppm). However, neither baseline nor withdrawal blood samples yielded detectable methanol and no residual methanol was detected in blood sampled from cattle fed crude glyerin.

TABLE 6
Methanol analysis results.

| Sample time¹ | | Baseline | Withdrawal² | Baseline | Withdrawal² |
|---|---|---|---|---|---|
| Item | Treatment | Rumen Fluid | Rumen Fluid | Plasma | Plasma |
| Calf 104 | Co-product | 1.83 | 5.88 | Not Detected | Not Detected |
| Calf 123 | Co-product | Not Detected | 3.34 | Not Detected | Not Detected |
| Calf 148 | Co-product | Not Detected | 2.93 | Not Detected | Not Detected |
| Calf 22 | Co-product | Not Detected | 9.5 | Not Detected | Not Detected |
| Calf 27 | Co-product | 2.04 | 1.98 | Not Detected | Not Detected |
| Calf 29 | Co-product | Not Detected | 2.22 | Not Detected | Not Detected |
| Calf 120 | Grain | 0.02 | 23.77 | Not Detected | Not Detected |
| Calf 5 | Grain | 4.26 | 6.05 | Not Detected | Not Detected |
| Calf 54 | Grain | 0.26 | 0.71 | Not Detected | Not Detected |
| Calf 87 | Grain | Not Detected | 5.3 | Not Detected | Not Detected |

### Example 4

In another embodiment, an evaluation was conducted to assess practical energy value of using glycerin as a feed ingredient for lactating dairy cattle. Sixty lactating Holstein cows were fed glycerin diets for 8 weeks following a 2-week adjustment to the control diet. Diets were balanced to meet energy requirements based on the control diet, be isonitrogenous, and balanced to meet or exceed requirements for all other nutrients. The basal ration contained corn silage, alfalfa haylage, hay, high-moisture corn, vitamins, and minerals, and was formulated to contain about 17% CP, 6.5% RUP, and 10.5 RDP (DM basis). The basal diet contained about 20% ground corn, which was progressively replaced by 5, 10, and 15% glycerin in the glycerin diets.

Results are presented in Table 7. The substitution of glycerin for ground corn did not significantly affect dry matter intake (DMI), milk production, or milk composition. Milk urea nitrogen was reduced with the addition of glycerin. Surprisingly, cows fed glycerin gained a greater amount of body weight than did the cows fed the control diet. This suggested that glycerin may have slightly greater energy value than corn or that, metabolically, the end products from glycerin were distributed more toward body requirements than lactation demands. When energy output in milk and body weight increase for the entire test was calculated, the estimated energy value of the entire diet was not significantly different with the incorporation of glycerin. These results support the use of glycerin at levels of about 10% of the diet, with an energy value approximately that of finely ground corn.

TABLE 7
Effect of glycerin on feed intake and milk production, body
weight changes and body condition score change.

| | % Glycerin Fed (DM Basis) | | | | | |
|---|---|---|---|---|---|---|
| Item | 0 | 5 | 10 | 15 | SEM | P (Trt) |
| Milk production, lb/day | 81.4 | 81.2 | 82.1 | 80.0 | 1.3 | 0.71 |
| Feed intake, lb/day | 52.8 | 53.9 | 54.1 | 53.0 | 1.2 | 0.82 |
| Efficiency, milk:feed | 1.56 | 1.52 | 1.52 | 1.53 | 0.04 | 0.85 |
| Milk fat, lb/d | 2.93 | 2.81 | 2.92 | 2.80 | 0.14 | 0.88 |
| Milk protein, lb/d | 2.19 | 2.28 | 2.33 | 2.28 | 0.09 | 0.78 |
| Milk lactose, lb/d | 3.66 | 3.71 | 3.88 | 3.68 | 0.18 | 0.84 |
| Milk solids, lb/d | 9.50 | 9.53 | 9.85 | 9.47 | 0.43 | 0.91 |
| Somatic Cell Count, 1000 cells/ml | 275 | 490 | 137 | 144 | 111 | 0.10 |
| Milk urea Nitrogen, mg/dl | 12.5^{a} | 10.9^{b} | 10.7^{b} | 10.2^{b} | 0.4 | ′<0.05 |
| Milk fat, % | 3.70 | 3.52 | 3.58 | 3.58 | 0.11 | 0.69 |
| Milk protein, % | 2.79 | 2.84 | 2.86 | 2.89 | 0.06 | 0.62 |
| Milk lactose, % | 4.64 | 4.62 | 4.70 | 4.66 | 0.07 | 0.89 |
| Milk solids, % | 12.05 | 11.89 | 12.03 | 12.04 | 0.19 | 0.91 |
| Body condition score change | 0.1 | 0.1 | 0.1 | 0.1 | 0.1 | 0.91 |
| Body Weight change, lbs. | 69.4^{a} | 89.6^{ab} | 109.3^{b} | 113.5^{b} | 10.2 | ′<0.05 |
| Estimated Net Energy for Lactation, mcal/kg* | 1.55 | 1.55 | 1.57 | 1.58 | 0.04 | 0.90 |

Means within the same row with different superscripts differ P < 0.05.
*Formulated Net Energy for Lactation for Control diet was 1.58 mcal/kg.

### Example 5

In another embodiment, the effect of crude glycerin was studied in growing ruminant diets. To determine an optimal inclusion level or its effects on performance in growing ruminants, fifty-six crossbred whether lambs (initial weight 25.9±1.1 kg) were utilized in a randomized, complete-block design to assess the feed value and optimal level of crude glycerin or glycerin in growing ruminants. Lambs received a common receiving ration for one week prior to allotment. Lambs were blocked by weight (4 blocks) and fed in individual crates for 28 days. Treatment diets included 0, 5, 10, 15, or 20% crude glycerin to replace cracked corn in a corn and co-product-based growing diet (59 Mcal/cwt NEg). Initial and final weights were collected on consecutive days and an interim weight was taken on day 14. Periods were: 1) days 1 to 14, 2) days 15 to 29, and 3) cumulative (days 1 to 29). By design, initial weight did not differ between treatments. On day 14, weight response tended (P=0.11) cubic with lambs fed 15% crude glycerin and control diets weighing numerically greater than other treatments. Final weight was not significantly different (P≧0.41).

Results are presented in Table 8. In period 1, ADG tended (P=0.11) cubic with lambs fed 15% crude glycerin diets gaining numerically more than other treatments. In period 2, ADG tended (linear, P=0.13; cubic, P=0.06) greater for lambs fed diets with 5% crude glycerin. Cumulative ADG was similar (P=0.55) for lambs fed crude glycerin up to 20% inclusion (0.39, 0.40, 0.36, 0.39, or 0.36 kg/d for 0, 5, 10, 15, or 20% crude glycerin, respectively). In period 1, DMI was cubic (P=0.01) with lambs fed 15% crude glycerin and control diets consuming more than other treatments. Greater intake explains numerically greater weights and ADG for lambs fed 0 or 15% crude glycerin. Period 2 and cumulative DMI was not different for lambs fed crude glycerin up to 20% inclusion (1.27, 1.26, 1.21, 1.27, or 1.20 kg/d for 0, 5, 10, 15, or 20% crude glycerin, respectively). Cumulative intake was excellent, averaging 3.5 to 4.0% of body weight and crude glycerin palatability is not a concern at levels of up to 20% dry matter (DM) inclusion.

TABLE 8
Performance results.

| Treatment Description | Control | +5% | +10% | +15% | +20% | | P Values | | | | |
|---|---|---|---|---|---|---|---|---|---|---|---|
| | | Glycerin | Glycerin | Glycerin | Glycerin | | | Glycerin | | | |
| Treatment # | 1 | 2 | 3 | 4 | 5 | SE | Treatment | Linear | Quadratic | Cubic | Quartic |

# of Lambs

| | | | | | |
|---|---|---|---|---|---|
| Day 0 | 12 | 11 | 11 | 11 | 11 |

Weight, kg

| | | | | | | | | | | | |
|---|---|---|---|---|---|---|---|---|---|---|---|
| Day 0 | 26.0 | 25.9 | 25.7 | 26.0 | 25.8 | 1.12 | 1.00 | | | | |
| Day 14 | 34.1 | 33.5 | 33.8 | 34.7 | 33.1 | 0.67 | 0.51 | 0.71 | 0.58 | 0.11 | 0.60 |
| Day 29 | 37.3 | 37.3 | 36.6 | 37.4 | 36.4 | 0.85 | 0.87 | 0.54 | 0.85 | 0.63 | 0.41 |

Average Daily Gain, kg/hd/d

| | | | | | | | | | | | |
|---|---|---|---|---|---|---|---|---|---|---|---|
| Day 1-14 | 0.58 | 0.57 | 0.55 | 0.62 | 0.53 | 0.03 | 0.34 | 0.63 | 0.59 | 0.12 | 0.20 |
| Day 15-29 | 0.21^{ab} | 0.25^{a} | 0.19^{b} | 0.18^{b} | 0.02^{ab} | 0.02 | 0.14 | 0.13 | 0.94 | 0.06 | 0.24 |
| Day 1-29 | 0.39 | 0.40 | 0.36 | 0.39 | 0.36 | 0.02 | 0.55 | 0.34 | 0.85 | 0.94 | 0.14 |

Dry Matter Intake, kg/hd/d

| | | | | | | | | | | | |
|---|---|---|---|---|---|---|---|---|---|---|---|
| Day 1-14 | 1.32^{ab} | 1.27^{abc} | 1.24^{bc} | 1.34^{a} | 1.20^{c} | 0.03 | 0.02 | 0.11 | 0.63 | 0.01 | 0.09 |
| Day 15-29 | 1.22 | 1.25 | 1.17 | 1.20 | 1.17 | 0.05 | 0.74 | 0.29 | 0.89 | 0.75 | 0.37 |
| Day 1-29 | 1.27 | 1.26 | 1.21 | 1.27 | 1.19 | 0.04 | 0.42 | 0.20 | 0.84 | 0.39 | 0.19 |

Gain/Feed, ×100

| | | | | | | | | | | | |
|---|---|---|---|---|---|---|---|---|---|---|---|
| Day 1-14 | 44.06 | 44.66 | 44.37 | 46.00 | 44.19 | 1.84 | 0.94 | 0.77 | 0.66 | 0.65 | 0.58 |
| Day 15-29 | 17.35^{ab} | 20.77^{a} | 16.32^{ab} | 14.84^{b} | 17.56^{ab} | 1.79 | 0.15 | 0.30 | 0.80 | 0.02 | 0.48 |
| Day 1-29 | 30.77 | 32.39 | 30.19 | 30.92 | 30.92 | 1.36 | 0.79 | 0.77 | 0.95 | 0.44 | 0.32 |
| Morbidity, % | 0.0 | 9.1 | 0.0 | 9.1 | 18.2 | | 0.42 | | | | |
| Mortality, % | 0.0 | 9.1 | 0.0 | 0.0 | 18.2 | | 0.22 | | | | |

^{a,b,c}Means within the same row with different superscripts differ P < 0.05.

In period 1, feed efficiency was not different (P>0.58) between treatments. Similar to ADG in period 2, feed efficiency tended (linear, P=0.15; cubic, P=0.02) greater for lambs fed diets with 5% crude glycerin. Cumulative feed efficiency was similar for lambs fed crude glycerin at up to 20% inclusion (0.3077, 0.3239, 0.3019, 0.3092, or 0.3092 kg gain/kg feed for 0, 5, 10, 15, or 20% crude glycerin, respectively). Cumulative growth efficiency ranged from 1.88% less to 5.26% greater for lambs fed diets containing crude glycerin relative to cracked corn. A low incidence of morbidity and mortality was observed among all lambs and treatment effects were not different (P≧0.22; mortalities due to broken leg, prolapse, and urinary calculi). Hence, growing ruminants fed crude glycerin as an energy ingredient performed similar to animals fed cracked corn, with comparable energy values.

### Example 6

In yet another embodiment, crude glycerin was evaluated as an energy source in swine nursery diets. A total of 165 pigs (Monsanto Choice Genetics, EB x GP37; initial weight: 7.14 kg) were used to determine the effect of Frostcoats coating technology and plasma addition on performance of nursery pigs. Pigs were blocked by initial weight to one of five dietary treatments with seven pens per treatment and four or five pigs per pen. The five dietary treatments were five levels of crude glycerin addition: 0, 3, 6, 9, and 12%. The basal diets were close to a typical corn-SBM diet with no animal fat added. Crude glycerin was used to replace corn in diet formulations and increased dietary energy because its energy value was assumed to be about 20% higher than corn's energy. Dietary protein, lysine (amino acid ratios), major minerals, and vitamins were equal across treatments within each phase. Digestible lysine was 1.25, 1.15, 1.15, and 1.05% for phases 1 to 4, respectively. Dietary lysine levels were high enough to be a limiting factor to observe energy effect. Feeding programs of Momentum grind-mix option (15-25, 25-35 and 35-50 lbs. BW) was the base program. The trial had four phases with 7, 7, 7, and 9 days, respectively. Before the pigs started the trial, the pigs were fed a common diet until the pigs weighed about 15.5 pounds. Medication choice for diets in this embodiment was Carbadox.

Results are presented in Table 9. Increasing dietary crude glycerin had no effects on daily gain, feed intake, or efficiency in phase 1 (P>0.10). However, as dietary crude glycerin increased, feed intake linearly increased in phases 2, 3, 4, and cumulative phases 1-2, 1-3, and 1-4 (P<0.05). Daily gain was decreased in phase 4 in a linear and quadratic manner (P<0.05) when dietary crude glycerin increased. Increasing dietary crude glycerin had a negative effect on feed efficiency in phases 2, 3, 4, and cumulative phases 1-2, 1-3, and 1-4 (P<0.05), which resulted from its effect on feed intake. Higher feed intake appeared to be due to an overestimate of crude glycerin in the formulations. Pigs were trying to consume more feed in order to get the same amount of total energy intake.

TABLE 9
Evaluation of crude glycerin as an energy source in swine energy diets.
Performance Data

| | | | | | | | | P Values | | | | |
|---|---|---|---|---|---|---|---|---|---|---|---|---|
| Treatment No. | 1 | 2 | 3 | 4 | 5 | | | | Glycerin | | | Pair-wise |
| Crude Glycerin, % | 0 | 3 | 6 | 9 | 12 | Mean | SE | Program | Linear | Quadratic | Cubic | Comparison¹ |
| No. pens/trt | 7 | 7 | 7 | 7 | 7 | | | | | | | |
| No. pigs/trt | 33 | 33 | 33(2)* | 33(1) | 33(1) | | | | | | | |

Weight, kg

| | | | | | | | | | | | | |
|---|---|---|---|---|---|---|---|---|---|---|---|---|
| Initial | 7.13 | 7.13 | 7.13 | 7.13 | 7.14 | 7.13 | 0.53 | | | | | |
| Stage 1, 8 d | 10.38 | 10.40 | 10.58 | 10.38 | 10.64 | 10.47 | 0.17 | 0.720 | 0.363 | 0.885 | 0.578 | |
| Stage 2, 7 d | 14.62 | 14.38 | 15.03 | 14.95 | 14.78 | 14.75 | 0.22 | 0.247 | 0.207 | 0.479 | 0.166 | Ef |
| Stage 3, 6 d | 18.43 | 18.41 | 18.74 | 18.79 | 18.80 | 18.63 | 0.23 | 0.602 | 0.145 | 0.801 | 0.607 | |
| Stage 4, 8 d | 24.63 | 24.16 | 24.39 | 24.30 | 24.60 | 24.42 | 0.34 | 0.837 | 0.936 | 0.339 | 0.772 | |

Daily Gain, kg

| | | | | | | | | | | | | |
|---|---|---|---|---|---|---|---|---|---|---|---|---|
| Stage 1, 8 d | 0.405 | 0.409 | 0.430 | 0.406 | 0.435 | 0.417 | 0.020 | 0.711 | 0.371 | 0.936 | 0.568 | |
| Stage 2, 7 d | 0.607 | 0.569 | 0.621 | 0.648 | 0.592 | 0.608 | 0.020 | 0.066 | 0.425 | 0.411 | 0.007 | eFJ |
| Stage 3, 6 d | 0.634 | 0.672 | 0.614 | 0.640 | 0.669 | 0.646 | 0.020 | 0.202 | 0.536 | 0.370 | 0.120 | Ei |
| Stage 4, 8 d | 0.775 | 0.718 | 0.707 | 0.689 | 0.726 | 0.723 | 0.020 | 0.036 | 0.042 | 0.016 | 0.883 | ABCd |
| Overall, S1-2 | 0.500 | 0.483 | 0.518 | 0.516 | 0.508 | 0.505 | 0.016 | 0.563 | 0.335 | 0.751 | 0.281 | |
| Overall, S1-3 | 0.538 | 0.537 | 0.544 | 0.551 | 0.554 | 0.545 | 0.014 | 0.866 | 0.293 | 0.860 | 0.801 | |
| Overall, S1-4 | 0.603 | 0.587 | 0.587 | 0.588 | 0.601 | 0.593 | 0.013 | 0.821 | 0.947 | 0.240 | 0.920 | |

Feed Intake, kg/d

| | | | | | | | | | | | | |
|---|---|---|---|---|---|---|---|---|---|---|---|---|
| Stage 1, 8 d | 0.422 | 0.435 | 0.455 | 0.432 | 0.462 | 0.441 | 0.015 | 0.326 | 0.119 | 0.858 | 0.354 | d |
| Stage 2, 7 d | 0.640 | 0.641 | 0.710 | 0.712 | 0.733 | 0.687 | 0.028 | 0.067 | 0.007 | 0.783 | 0.581 | bcDefG |
| Stage 3, 6 d | 1.126 | 1.100 | 1.248 | 1.239 | 1.359 | 1.214 | 0.065 | 0.060 | 0.007 | 0.586 | 0.830 | DG |
| Stage 4, 8 d | 1.198 | 1.187 | 1.343 | 1.252 | 1.287 | 1.253 | 0.032 | 0.013 | 0.026 | 0.207 | 0.683 | BdEGh |
| Overall, S1-2 | 0.523 | 0.531 | 0.572 | 0.560 | 0.588 | 0.555 | 0.020 | 0.141 | 0.018 | 0.862 | 0.919 | bDg |
| Overall, S1-3 | 0.695 | 0.694 | 0.760 | 0.752 | 0.808 | 0.742 | 0.031 | 0.073 | 0.008 | 0.725 | 0.967 | DG |
| Overall, S1-4 | 0.834 | 0.830 | 0.916 | 0.889 | 0.940 | 0.882 | 0.027 | 0.030 | 0.004 | 0.974 | 0.889 | BDEG |

Feed/Gain

| | | | | | | | | | | | | |
|---|---|---|---|---|---|---|---|---|---|---|---|---|
| Stage 1, 8 d | 1.046 | 1.068 | 1.065 | 1.070 | 1.062 | 1.062 | 0.031 | 0.982 | 0.728 | 0.647 | 0.910 | |
| Stage 2, 7 d | 1.053 | 1.131 | 1.157 | 1.096 | 1.240 | 1.135 | 0.046 | 0.085 | 0.029 | 0.793 | 0.090 | DgJ |
| Stage 3, 6 d | 1.781 | 1.636 | 2.036 | 1.947 | 2.054 | 1.891 | 0.106 | 0.045 | 0.017 | 0.969 | 0.309 | bdEFG |
| Stage 4, 8 d | 1.549 | 1.651 | 1.906 | 1.849 | 1.777 | 1.746 | 0.063 | 0.003 | 0.003 | 0.010 | 0.407 | BCDEF |
| Overall, S1-2 | 1.048 | 1.101 | 1.110 | 1.084 | 1.155 | 1.100 | 0.029 | 0.167 | 0.045 | 0.990 | 0.138 | Dj |
| Overall, S1-3 | 1.294 | 1.292 | 1.397 | 1.365 | 1.463 | 1.362 | 0.047 | 0.084 | 0.011 | 0.722 | 0.886 | DG |
| Overall, S1-4 | 1.384 | 1.413 | 1.562 | 1.514 | 1.565 | 1.488 | 0.042 | 0.013 | 0.002 | 0.344 | 0.871 | BCDEfG |

*Numbers in parentheses are numbers of pigs removed during the trial.
¹A lower case letter refers to .05 < P < .10 and an upper case letter refers to P < .05.
A or a = Trt 1 vs. Trt 2
B or b = Trt 1 vs. Trt 3
C or c = Trt 1 vs. Trt 4
D or d = Trt 1 vs. Trt 5
E or e = Trt 2 vs. Trt 3
F or f = Trt 2 vs. Trt 4
G or g = Trt 2 vs. Trt 5
H or h = Trt 3 vs. Trt 4
I or i = Trt 3 vs. Trt 5
J or j = Trt 4 vs. Trt 5

The assumed ME value for crude glycerin was based on preliminary research data from Europe. Based on this dataset, every 1% inclusion of crude glycerin (assuming 20% higher ME than corn) in the diets had 1.18% negative effect on feed efficiency. Feed efficiency data was regressed against daily ME intake to estimate ME content for crude glycerin. This approach found ME content of crude glycerin was about 1 to 2% lower than corn's ME value. Because overall growth performance was similar among the five dietary treatments, the inclusion of up to 12% crude glycerin in late nursery diets would not have negative effects on performance if its energy value was correct. Gross energy of the test crude glycerin sample (with 14.8% moisture) was measured at 3845 kcal/kg. Data from this embodiment suggested that the test crude glycerin did not have 20% higher energy value than corn. The crude glycerin's energy value should be similar to or lower than corn. Including up to 12% crude glycerin did not affect daily gain, indicating it is an acceptable ingredient in late nursery diets.

### Example 7

Forty-eight lactating Holstein cows (twelve per treatment) were used in a randomized complete block design to determine the effect of feed additives on production efficiency. Four dietary treatments were evaluated for 56 days; 1) control, 2) heat stress product, 3) 2+extract, and 4) 2+454 g/d glycerin. Treatments 2 and 4 will be the focus of this example. Diets were corn silage based and formulated to be iso-nitrogenous. Cows were housed in a free-stall barn with access to individual stalls. Training for Calan door use was initiated in mid-May, the standardization period occurred in early June and the treatment period started in late June and continued through early August. Feed was mixed and delivered once daily and fed behind electronic Calan doors, allowing individual intake to be determined. Ad libitum intakes were adjusted to achieve orts of 7-10% daily. Cows were milked twice daily at 0400 and 1500. Feed intake, milk yield and composition, body temperature, and body weight changes were monitored. Results are presented in Table 10.

TABLE 10
Performance of lactating Holstein cows fed diets
supplemented with heat stress product with and without glycerin.

| Item | Control | Glycerin |
|---|---|---|
| DMI, kg/d | 23.26 | 23.49 |
| Milk, kg/d | 38.95 | 38.53 |
| Primiparous | 39.28 | 40.42 |
| Multiparous | 38.62 | 36.63 |
| Milk fat, % | 3.60 | 3.90 |
| Milk protein, % | 2.76 | 2.93 |
| ECM¹, kg/d | 37.29 | 39.40 |
| Production Efficiency, | 1.66 | 1.64 |
| (milk/DMI) | | |
| Production Efficiency, | 1.56 | 1.70 |
| (ECM/DMI) | | |
| BW change², (kg/d) | 0.133 | 0.779 |
| NE intake, (Mcal/d) | 37.91 | 38.74 |
| NE milk³, (Mcal/d) | 25.37 | 27.07 |
| NE Balance⁴, (Mcal/d) | 2.83 | 6.15 |

¹Energy corrected milk = (.3246 × kg milk) + (12.86 × kg fat) + (7.04 × kg protein).
²Difference in body weights using a weekly rolling average
³NE milk = Milk (kg/d) × [(0.0929 × BFT %) + (0.0563 × Pro %) + 0.192)]
⁴NE Balance = (NE intake (Mcal/d) − NE maintenance (Mcal/d) ± NE of tissue change (Mcal/d) − NE of milk (Mcal/d))/7

DMI was not different among treatment groups. Based on intake glycerin was consumed at 4.26% of diet DM. Milk production was not affected by treatment group (P<0.53). Primiparous cows offered glycerin produced numerically more milk than primiparous cows fed the other diets. Milk fat, milk protein, and energy corrected milk yield tended greater for cows fed glycerin. Body weight change was greater for cows fed glycerin. Retained net energy for lactation and/or body weight gain is significantly greater for cows fed glycerin. Resulting energetic efficiency (milk+body weight per unit of feed input) was improved with glycerin added to the diets. The extra energy provided by the glycerin improved production, particularly in primiparous animals. Positive results have been seen in mid-lactation cows. The inclusion of these products at an earlier stage of lactation may lead to significant benefits throughout the lactation.

The present invention has been described with reference to certain exemplary embodiments, compositions and uses thereof. However, it will be recognized by those of ordinary skill in the art that various substitutions, modifications or combinations of any of the exemplary embodiments may be made without departing from the spirit and scope of the invention. Thus, the invention is not limited by the description of the exemplary embodiment, but rather by the appended claims as originally filed.

1. A process for producing an animal feed, comprising:
mixing a source of glycerin having less than 99.0% glycerin and less than 1000 ppm methanol with an animal feed component.

2. The process of claim 1, wherein the animal feed component is selected from the group consisting of switch grass, corn fiber, corn gluten feed, corn gluten meal, soy protein, soy fiber, soy hulls, cocoa hulls, corn cobs, corn husks, corn stover, wheat straw, wheat chaff, distiller dry grains, distillers dry grains with solubles, barley straw, rice straw, flax hulls, soy meal, corn meal, wheat germ, corn germ, wood chips, sawdust, shrubs, grasses, malt sprouts, whole grains, corn, milo, wheat, barley, protein supplements, minerals, trace minerals, vitamins, water, corn steep liquor, condensed distillers' solubles, molasses, corn syrup, fermentation solubles, fermentation liquors, amino acids, fats, oils, lecithin canola protein, canola fiber, soapstocks, and combinations of any thereof.

3. The process of claim 1, further comprising subjecting the animal feed component and the source of glycerin to pressure, thus producing an animal feed pellet.

4. The process of claim 3, wherein subjecting the animal feed component and the source of glycerin to pressure comprises compacting the animal feed component and the source of glycerin in a die.

5. The process of claim 3, further comprising cooling the animal feed pellet, drying the animal feed pellet, or a combination thereof.

6. A process for producing a product comprising mixing the product of claim 1 with feed dry matter.

7. The process of claim 1, wherein the animal feed is in an aqueous solution.

8. The process of claim 1, wherein the source of glycerin makes up between 0.5 to 50 percent by weight of the product.

9. The process of claim 1, wherein the animal feed is selected from the group consisting of corn silage, alfalfa haylage, hay, high-moisture corn, vitamins, minerals, a protein, an amino acid and any combination thereof.

10. The process of claim 1, wherein the animal feed is a rumen protected animal feed.

11. The process of claim 1, further comprising mixing the source of glycerin and the animal feed with a product selected from the group consisting of a botanical extract, a capsaicin containing compound, methoprene on a solid carrier, sorbitan, isosorbide, polyglycerin, sorbitol, xylitol, mannitol, and combinations of any thereof.

12. The process of claim 1, wherein the source of glycerin comprises less than 150 ppm methanol.

13. A product produced by the process of claim 1.

14. A method of improving carcass marbling score in an animal, improving carcass ribeye area in an animal, improving body weight gain per unit of feed input in an animal, improving body weight gain per unit of feed input in an animal, improving milk production in an animal, improving carcass gain per unit feed input in an animal, improving energetic efficiency in a growing and/or lactating animal per unit of feed input, and any combinations thereof, the method comprising:
feeding a source of glycerin having less than 99.0% glycerin and less than 1000 ppm methanol to the animal.

15. The method of claim 14, wherein the source of glycerin is fed to the animal at a level of between 0.5 and 25% of the weight of the feed input.

16. (canceled)

17. An animal feed composition comprising:
a source of glycerin having less than 99.0% glycerin and less than 1000 ppm ethanol;
an animal feed component.

18. The animal feed composition of claim 17, wherein the animal feed component is selected from the group consisting of switch grass, corn fiber, corn gluten feed, corn gluten meal, soy protein, soy fiber, soy hulls, cocoa hulls, corn cobs, corn husks, corn stover, wheat straw, wheat chaff, distiller dry grains, distillers dry grains with solubles, barley straw, rice straw, flax hulls, soy meal, corn meal, wheat germ, corn germ, wood chips, sawdust, shrubs, grasses, malt sprouts, whole grains, corn, milo, wheat, barley, protein supplements, minerals, trace minerals, vitamins, water, corn steep liquor, condensed distillers' solubles, molasses, corn syrup, fermentation solubles, fermentation liquors, amino acids, fats, oils, lecithin, canola protein, canola fiber, soapstocks and combinations of any thereof.

19. The animal feed composition of claim 17, wherein the source of glycerin comprises less than 150 ppm methanol.

20. The animal feed composition of claim 17, wherein the animal feed composition takes the form of a pellet and has a greater pellet durability index than a pellet formed without the source of glycerin.

21. The animal feed composition of claim 17, further comprising an ingredient selected from the group consisting of a botanical extract, a capsaicin containing compound, methoprene on a solid carrier, sorbitan, isosorbide, polyglycerin, sorbitol, xylitol, mannitol, and combinations of any thereof.

22-23. (canceled)
